(19) United States
(12) Patent Application Publication
(10) Pub. No.: US 2002/0154138 A1
(43) Pub. Date: Oct. 24, 2002

(54) Environment adaptive image display system, image processing method and information storing medium

(76) Inventors: Osamu Wada, Ina-shi (JP); Kenji Fukasawa, Matsumoto-shi (JP); Masashi Kanai, Matsuhoto-shi (JP); Hideki Matsuda, Fujimi-cho (JP)

Correspondence Address: Oliff & Berridge, PO Box 19928, Alexandria, VA, 22320, US

(21) Appl. No.: 10/111,357

(22) PCT Filed: Aug. 28, 2001
(86) PCT No.: PCT/JP01/07376

(30) Foreign Application Priority Data
Aug. 28, 2000 (JP) 2000-257161

(51) Int. Cl. G09G 5/02

(52) U.S. Cl. 345/600; 345/601

(57) ABSTRACT

There are provided an image display system of environment-compliant type, image display method and information storage medium which can reproduce color of an image suiting taste of a user. A color conversion LUT generating section 160 is used to correct a look-up table in an LUT storage section 122 based on a target profile in a target profile storage section 162 selected by a user, a projector profile in a projector profile storage section 164 and viewing environment information from a color light sensor 60 which detects the viewing environment, and the corrected look-up table is then used to display an image.

### TECHNICAL FIELD

The present invention relates to an image display system of environment-compliant type, an image processing method and an information storage medium.

### BACKGROUND OF ART

There has been proposed an image display system of environment-compliant type which detects a viewing environment (or work environment) effected by ambient lights and the like and corrects an image taking the viewing environment into consideration.

However, the real desirable image may be seen differently depending on individuals or in areas.

For example, the standard display mode in Japan is NTSC, but the standard display mode in Europe is PAL.

Therefore, if an image generated assuming NTSC in Japan is displayed for Europeans in Europe, the way in which the displayed image is seen may be different from what Europeans think to be desirable.

### DISCLOSURE OF INVENTION

In view of the above problem, the present invention may provide an image display system of environment-compliant type, an image processing method and an information storage medium which can reproduce the image appearance(s) to conform to an image characteristic selected by a user.

(1) To this end, the present invention relates to an image display system of environment-compliant type which corrects image display information for displaying an image and displays the image, based on viewing environment information obtained by a viewing environment detection means which detects a viewing environment in a display area of the image, the image display system comprising:

correction means for correcting the image display information based on the viewing environment information and an image characteristic selected by a user so that the image is displayed conforming to the image characteristic; and

image display means for displaying the image based on the corrected image display information.

(2) The present invention also relates to an image display system of environment-compliant type which corrects image display information for displaying an image and displays the image, based on viewing environment information obtained by a viewing environment detection means which detects a viewing environment in a display area of the image, the image display system comprising:

a correction section which corrects the image display information based on the viewing environment information and an image characteristic selected by a user so that the image is displayed conforming to the image characteristic: and an image display section which displays the image based on the corrected image display information.

(3) The present invention further relates to an image processing method of environment-compliant type which corrects image display information for displaying an image, based on viewing environment information indicating a viewing environment in a display area of the image, the image processing method comprising:

a step for a user to select a given image characteristic; and

a step of correcting the image display information based on the viewing environment information and the image characteristic selected by the user so that the image is displayed conforming to the image characteristic.

(4) The present invention further relates to a computer-readable information storage medium which stores program that corrects image display information for displaying an image and displays the image, based on viewing environment information obtained by a viewing environment detection means which detects a viewing environment in a display area of the image, the information storage medium comprising program to implement on a computer:

correction means which corrects the image display information based on the viewing environment information and an image characteristic selected by a user so that the image is displayed conforming to the image characteristic; and

means which causes image display means to display the image based on the corrected image display information.

According to the present invention, an image suiting taste of a user can be displayed by correcting the image information so that the image will be displayed conforming to the image characteristic selected by the user.

(5) The image display system may comprise a projector type display device including:

the correction means;

the image display means; and

means for generating a calibration image,

the image display means may project the generated calibration image onto the display area, and

the viewing environment detection means may detect the viewing environment in the display area on which the calibration image is displayed.

In such an arrangement, the projector type display device can solely perform the calibration, without inputting a calibration image from any external input device such as PC or the like into the projector type display device, because the calibration image is generated by the projector type display device itself.

(6) The image processing method may further comprise:

a step of generating a calibration image before correcting the image information;

a step of displaying the generated calibration image on the display area; and

a step of detecting the viewing environment in the display area on which the calibration image is displayed and generating the viewing environment information.

(7) The information storage medium may further comprise program to implement means which generates the calibration image on a computer,

the means which causes image display means to display the image may cause the image display means to display the generated calibration image on the display area, and

the viewing environment detection means may detect the viewing environment in the display area on which the calibration image is displayed.

Thus, the viewing environment can more appropriately be detected by detecting the viewing environment using the calibration image. This makes it possible to reproduce the image appearance(s) more appropriately.

(8) In the image display system, image processing method and information storage medium, the image characteristic may be based on at least one of image display mode and image type.

Thus, the image can be displayed conforming to the image display mode or image type selected by the user.

The image display mode may be NTSC, PAL, SECAM or the like.

The image type may be RGB, sRGB or the like.

(9) In the image display system, image processing method and information storage medium, the image display information may include a look-up table.

This makes it possible to adjust the way in which color of the displayed image is seen by correcting the look-up table.

(10) In the image display system, image processing method and information storage medium,

the image display information may include a color correction look-up table and a brightness correction look-up table, and

the correction means may individually correct the color correction look-up table and brightness correction look-up table based on the viewing environment information and the image characteristic.

(11) In the image processing method,

the image display information may include a color correction look-up table and a brightness correction look-up table, and

the correcting step may include:

a step of correcting the color correction look-up table based on the viewing environment information and the image characteristic; and

a step of correcting the brightness correction look-up table based on the viewing environment information and the image characteristic.

Thus, the color may more appropriately be reproduced by correcting the color correction look-up table and the brightness correction look-up table.

### BRIEF DESCRIPTION OF DRAWINGS

FIG. 1 is a schematic illustration of an image display system according to an example of this embodiment.

FIG. 2 is a functional block diagram of an image processing section in a conventional projector.

FIG. 3 is a functional block diagram of an image processing section in a projector according to an example of this embodiment.

FIG. 4 is a flow chart showing a procedure of image processing according to an example of this embodiment.

### BEST MODE FOR CARRYING OUT THE INVENTION

The description below relates to a case in which the present invention is applied to an image display system which uses a liquid-crystal projector, with reference to the accompanying figures. Note that the embodiments described herein do not in any way limit the scope of the invention as defined by the claims. Similarly, the entirety of the configuration described for these embodiments does not place any limitations on the essential components of the means in accordance with the present invention, as laid out herein.

Description of Overall System

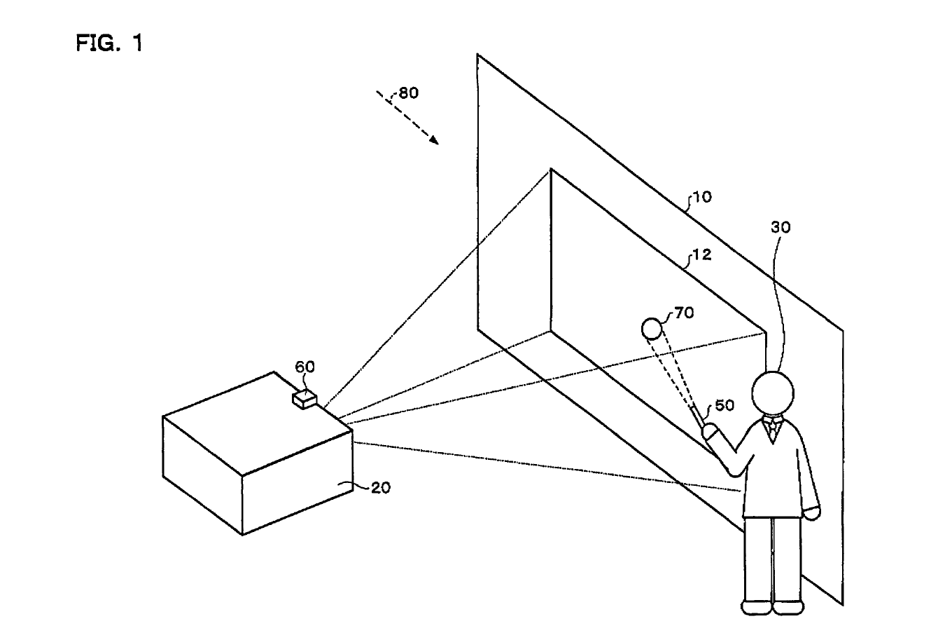

A schematic illustrative view of an image display system in accordance with an example of this embodiment of the present invention is shown in FIG. 1.

A projector 20, which is a projector-type display device provided substantially facing a screen 10, projects a given image for presentation. A presenter 30 gives a presentation to an audience, while using a light spot 70 projected from a laser pointer 50 to point at a desired position of an image in an image display region 12, which is a display area on the screen 10.

During such a presentation, the way in which images on the image display region 12 are seen will vary greatly. depending on factors such as the type of the screen 10 and ambient light 80. When the projector 20 displays the same white, for example, the type of the screen 10 could make it seem to be white with a yellow cast or white with a blue cast. Similarly, differences in the ambient light 80 could make the same white that is displayed by the projector 20 appear to be a bright white or a dull white.

In recent years, this projector 20 has become smaller and easier to transport. For that reason, it has become possible for the presenter 30 to perform presentations at a client's location, by way of example, but it is difficult to adjust colors to match the environment at the client's location and the manual adjustment of colors at the client's location takes too much time.

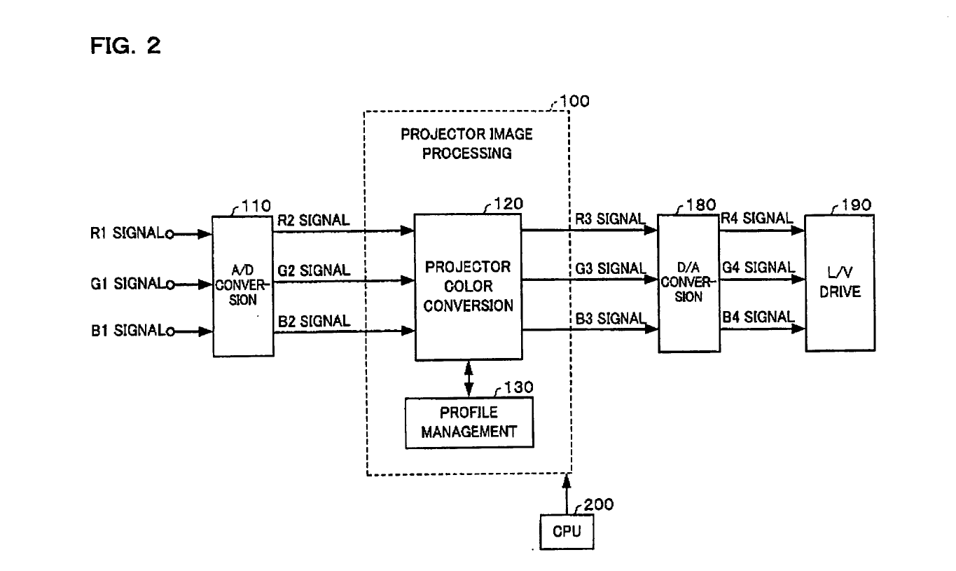

A functional block diagram of the image processing section within a conventional projector is shown in FIG. 2.

This conventional projector inputs an R1 signal, a G1 signal, and a B1 signal, which form RGB signals in analog format sent from a PC or the like, to an A/D conversion section 110 and then the input signals are color-converted into digital format of an R2 signal, a G2 signal, and a B2 signal by a projector image processing section 100.

An R3 signal, a G3 signal, and a B3 signal that have been subjected to the color conversion are input to a D/A conversion section 180, and an R4 signal, a G4 signal, and a B4 signal that have been converted into analog form are input to a light valve (L/V) drive section 190, to drive a liquid-crystal light valve and thereby display an image.

The projector image processing section 100, which is controlled by a CPU 200, comprises a projector color conversion section 120 and a profile management section 130.

The projector color conversion section 120 converts the RGB digital signals (the R2 signal, G2 signal, and B2 signal) from the A/D conversion section 110 into RGB digital signals for projector output (the R3 signal, G3 signal, and B3 signal), based on a projector input-output profiles that are managed by the profile management section 130. Note that “profile” in this case refers to characteristic data.

In this manner, the conventional projector can only perform color conversion based on input-output profiles that indicate input-output characteristics which are specific to that particular projector, and thus no consideration is paid to the viewing environment in which the image is projected and displayed.

However, it is difficult to ensure that the color appearance(s) is uniform with this configuration, without taking the viewing environment into account. The color appearance(s) is determined by three factors: light, the reflection or transmission of light by objects, and vision.

This embodiment implements an image display system which can reproduce an appropriate color by detecting the viewing environment of light including the reflection or transmission of light by object.

By the way, the color which is considered to be appropriate may be variable depending on the user or the area in which the color is to be reproduced.

For example, when the projector 20 is used in Japan, it is considered that the user generally desires the reproduction of image color through the NTSC mode. However, when the projector 20 is used in Europe, it is expected that the user generally desires the reproduction of image color through the PAL mode.

In such a case, the image color required by the user must be reproduced without dependent on the area in which the projector 20 is to be used.

This embodiment forms the projector 20 so that it can adjust the image color depending on the image display mode selected by the user.

More particularly, as shown in FIG. 1, this embodiment provides a color light sensor 60 functioning as viewing environment detection means which detects the viewing environment. The viewing environment information from the color light sensor 60 is inputs to the projector 20. The color light sensor 60 measures the viewing environment information of the image display region 12 in the screen 10 (more particularly, RGB or XYZ tristimulus values).

The projector 20 is provided with means which corrects image display information used for image display, based on selected information such as the viewing environment information from the color light sensor 60 and the image display mode selected by the user.

This embodiment implements an image display system which can reproduce an appropriate image color suiting the taste of a user by detecting the viewing environment based on the viewing environment information and then detecting the taste of a user based on the selected information.

A description will be made of a functional block relating to the image processing section in the projector 20, including these correction means or the like.

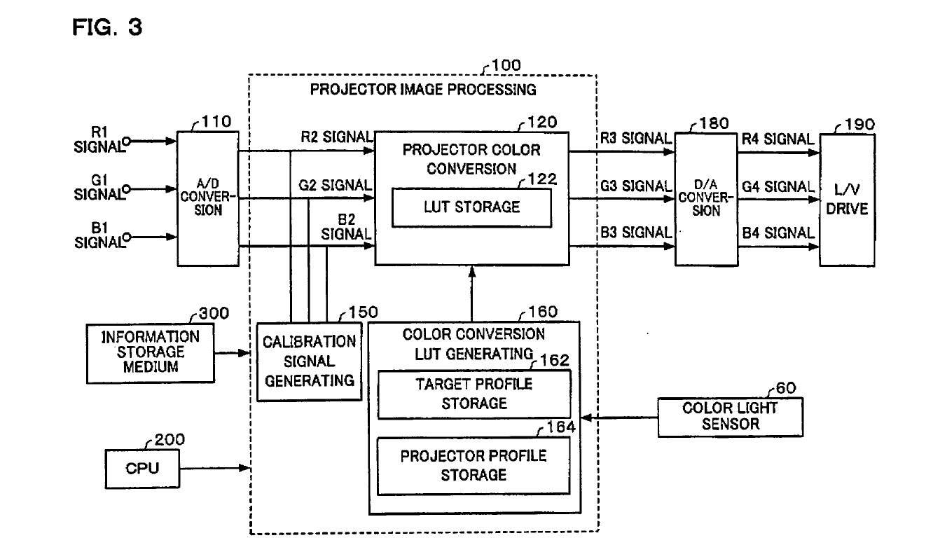

FIG. 3 is a functional block diagram of an image processing section in a projector 20 according to this embodiment.

In the projector 20, R1, G1 and B1 signals forming analog RGB signals from PC or the like are input into the A/D conversion section 110. The input signals are color-converted into Digital R2, G2 and B2 signals by the projector image processing section 100 which is controlled by CPU 200.

The projector 20 then inputs the color-converted R3, G3 and B3 signals into the D/A conversion section 180 and the analog-converted R4, G3 and B4 signals into L/V (light valve) drive section 190 which in turn drives the liquid crystal light valve to project the image.

The arrangement described hitherto is not different from that of the conventional projector. The projector image processing section 100 in the projector 20 according to this embodiment comprises a projector color conversion section 120, a target profile storage section 162, a projector profile storage section 164 (which is equivalent to the profile management section 130), a color conversion LUT generating section 160, an LUT storage section 122 and a calibration signal generating section 150.

The calibration signal generating section 150 generates calibration image signals. These calibration image signals are input into the projector color conversion section 120 as digital R2, G2 and B2 signals, as in the signals output from the A/D conversion section 110.

The projector color conversion section 120 refers to the projector profile managed by the projector profile storage section 164 for the respective digital RGB signals (R2, G2 and B3 signals) which are in turn converted into digital RGB signals (R3, G3 and B3 signals) appropriate for projector output.

The projector color conversion section 120 comprises an LUT storage section 122 which has stored a look-up table (LUT) that forms part of the image display information. more particularly, the LUT storage section 122 has stored a one-dimensional look-up table (3D-LUT) to be used for brightness correction and a three-dimensional look-up table (3D-LUT) to be used for color correction.

The look-up tables 1D-LUT includes a gamma table and a color balance table while the look-up table 3D-LUT including a color gamut correction table and a color temperature correction table.

By using the look-up table 3D-LUT for color correction, the color compression, color expansion and the like, which would not easily be accomplished by the look-up table 1D-LUT, can be controlled to reproduce an accurate color. Thus, the color can more appropriately be reproduced by independently managing the brightness correction look-up table 1D-LUT and color correction look-up table 3D-LUT.

In this embodiment, furthermore, the projector image processing section 100 is provided with the color conversion LUT generating section 160 which corrects the LUT in the LUT storage section 122 based on the viewing environment information and the like from the color light sensor 60.

The color conversion LUT generating section 160 comprises a target profile storage section 162 and a projector profile storage section 164. More particularly, the color conversion LUT generating section 160 corrects the LUT in the LUT storage section 122 based on the target profile selected by the user, the viewing environment information and projector profile from the color light sensor 60 so that the way in which image color is seen will suit the taste of a user and also the viewing environment.

The target profile is a kind of input/output characteristic data of a color that should be targeted. A plurality of target profiles will be provided depending on the characteristics in plural kinds of images which can be selected by the user.

More particularly, the target profile may be data indicating RGB luminance signals and tristimulus values (X, Y, z) correlated with these RGB luminance signals. In other words, the target profile defines the correlation between the RGB luminance signals and the tristimulus values (X, Y, Z). In this embodiment, the target profile storage section 162 is implemented using a memory which has stored the target profiles.

The projector profile is a kind of input/output characteristics data corresponding to the type of the projector 20.

More particularly, the projector profile may be data defining the relationship between the RGB luminance signals and the tristimulus values (X, Y, Z) which are obtained when the projector 20 actually displays the RGB luminance signals under an ideal environment. In this embodiment, the projector profile storage section 164 is implemented using a memory which has stored the projector profiles.

In such a manner, a presentation image can be displayed after it has appropriately been corrected to suit the taste of a user and the viewing environment by correcting the LUT for each gray scale.

Explanation of Processing Flows

The flows of image processing in connection with the respective aforementioned sections will be described with reference to a flowchart.

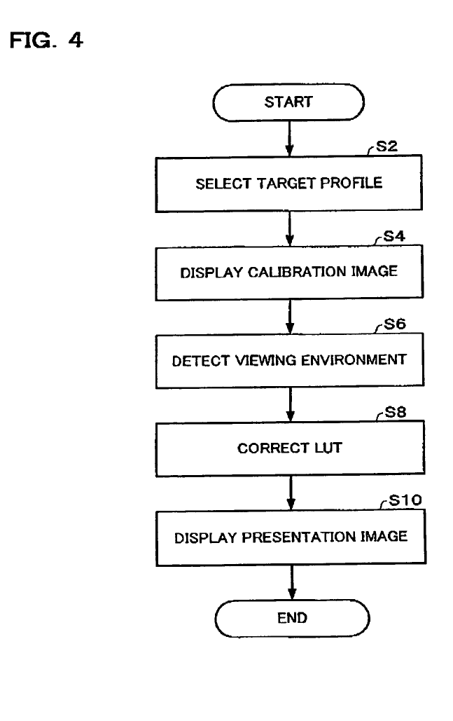

FIG. 4 is a flowchart showing a procedure of image processing according to an example of this embodiment.

First of all, a target profile selection image is displayed on the screen 10 through the projector 20 prior to the presentation. The selection image shows an image for selecting either of NTSC, PAL or SECAM.

The user then selects one image characteristic from plural kinds of image characteristics which have been assigned to operation buttons on the projector 20. More particularly, a plurality of selection buttons for selecting various image characteristics such as NTSC, PAL, SECAM and so on are provided on the outside of the projector 20. The user pushes one of these selection buttons to select one of the image characteristics.

This selection information is transmitted to the projector image processing section 100 which in turn uses the received selection information to turn on the flag of a target profile selected from a plurality of target profiles in the target profile storage section 162.

In this way, the projector image processing section 100 selects the target profile depending on the selection by the user (step S2).

After the target profile has been selected depending on the user's selection, the projector 20 causes the calibration signal generating section 150 to generate calibration signals (R2, G2, B2).

The calibration signal generating section 150 outputs these calibration signals toward the projector color conversion section 120.

The projector color conversion section 120 uses the default (initial) LUT stored in the LUT storage section 122 to convert the calibration signals into digital RGB signals (R3, G3, B3) to output.

The D/A conversion section 180 converts the digital RGB signals into analog RGB signals (R4, G4, B4). The L/V drive section 190 drives the liquid crystal light valve based on the analog RGB signals (R4, G4, B4). Moreover, the projector 20 projects the calibration image onto the image displaying region 12 (step S4).

While the calibration image is being displayed on the image displaying region 12, the color light sensor 60 detects tristimulus values in order to detect the viewing environment (step S6).

The color conversion LUT generating section 160 corrects the LUT in the LUT storage section 122 to reproduce a target color, based on the target profile selected from the target profile storage section 162, the projector profile stored in the projector profile storage section 164 and the tristimulus values detected by the color light sensor 60 (step S8).

More particularly, the color conversion LUT generating section 160 generates a gamma correction table, a white balance correction table, a color gamut correction table and a color temperature table in the LUT storage section 122. all of which tables suit the reproduction of the target color.

Actually, the procedure from the calibration image display step (S2) to the LUT correction step (S2) is carried out for a given gray scale unit (e.g., 16 gray scales).

In this way, the projector 20 displays calibration images for all the gray scales and generates an LUT corresponding for each gray scale.

After the LUTs corresponding to all the gray scales have been generated, the projector 20 displays an actual presentation image (step S10). On displaying the presentation image, the projector 20 uses the LUTs that were adjusted corresponding to the image characteristic (or target profile) selected by the user in the LUT storage section 122 and to reproduce the image reflecting the viewing environment.

As described, this embodiment correcting the LUTs to display the image which conforms to the image characteristic selected by the user.

Thus, this embodiment can implement the image display system which can display the image suiting taste of a user.

In addition, this embodiment uses the color light sensor 60 to detect the viewing environment so that the image can be projected and displayed taking the viewing environment into consideration.

As a result, this embodiment can display the image complying to the viewing environment at the time of display and can display the same image by absorbing the difference between various display environments irrespective of the applied environment. Therefore, this embodiment can rapidly reproduce substantially the same color at a plurality of different places.

Description of Hardware

Note that the hardware described below by way of example can be used to implement the above described components.

For example, the configuration could be implemented by an A/D converter or the like as the A/D conversion section 110; a D/A converter or the like as the D/A conversion section 180; a liquid-crystal light valve driver as the L/V drive section 406; an image processing circuit and ASIC or the like as the projector color conversion section 120 and the color conversion LUT generating section 160; and circuitry having a storage area such as RAM or the like as the LUT storage section 122, the target profile storage section 162 and the projector profile storage section 164. Note that these portions may be implemented in a hardware fashion by circuitry, or they may be implemented in a software fashion by drivers.

In addition, the functions of the components shown in FIG. 3 may be implemented by reading out a program from an information storage medium 300. The information storage medium 300 could be a CD-ROM, DVD-ROM, ROM, RAM, or HDD, by way of example, and the method of reading the program therefrom could be a direct method or an indirect method.

Instead of the information storage medium 300, it is possible to implement the above described functions by downloading a program that implements those functions from a host device or the like over a transfer path. In other words, a program for implementing these functions may be embodied over carrier waves.

The hardware described below may be employed for the color light sensor 60.

For example, the color light sensor 60 may be implemented by using a color filter that selectively passes the tristimulus values, a photodiode, an A/D converter that converts analog signals from the photodiode into digital signals and an OP amp that amplifies the digital signals.

Note the present invention has been described above by way of an embodiment thereof, but the application of the present invention is not limited to the above embodying example.

Modifications

For example, the target profile may be any other image characteristic such as RGB, sRGB or the like, than the image display modes such as NTSC and so on.

The viewing environment detection means may be any other suitable image capturing means such as CCD camera, CMOS camera or the like, rather than the color light sensor 60.

Although the screen 10 has been described as to the reflection type, but it may be of transmission type.

The present invention can also be applied to presentations in which images are displayed by a display means other than a projection means such as the above described projector. Apart from a liquid-crystal projector, this display means could be a display device such as a cathode ray tube (CRT). a plasma display panel (PDP). a field emission device (FED), an electro-luminescence (EL) device, or a direct-view type of liquid crystal display device, or a projector using a digital micromirror device (DMD), by way of example. Note that DMD is a tradename registered by Texas Instruments Inc., of the US. In addition, the projector is not limited to a front-projection-type device; it may equally well be of a rear-projection type.

In addition to presentations, this invention is also effective in the display of images such as those at meetings, during medical treatment, in the design and fashion fields, business activities, commercials, and education, as well as general-purpose images such as those in movies, TV, videos, and games.

Note that the functions of the above-described projector image processing section 100 of the projector 20 may be implemented by a single image display device (such as the projector 20 itself) or by distribution between a plurality of processing devices (such as distributed processing between the projector 20 and a PC).

1. An image display system of environment-compliant type which corrects image display information for displaying an image and displays the image, based on viewing environment information obtained by a viewing environment detection means which detects a viewing environment in a display area of the image, the image display system comprising:
correction means for correcting the image display information based on the viewing environment information and an image characteristic selected by a user so that the image is displayed conforming to the image characteristic; and
image display means for displaying the image based on the corrected image display information.

2. The image display system as defined by claim 1,
wherein the image characteristic is based on at least one of image display mode and image type.

3. The image display system as defined by claim 2, further comprising a projector type display device including:
the correction means;
the image display means; and
means for generating a calibration image,
wherein the image display means projects the generated calibration image onto the display area, and
wherein the viewing environment detection means detects the viewing environment in the display area on which the calibration image is displayed.

4. The image display system as defined by claim 3,
wherein the image display information includes a look-up table.

5. The image display system as defined by claim 3,
wherein the image display information includes a color correction look-up table and a brightness correction look-up table, and
wherein the correction means individually corrects the color correction look-up table and brightness correction look-up table based on the viewing environment information and the image characteristic.

6. An image display system of environment-compliant type which corrects image display information for displaying an image and displays the image, based on viewing environment information obtained by a viewing environment detection means which detects a viewing environment in a display area of the image, the image display system comprising:
a correction section which corrects the image display information based on the viewing environment information and an image characteristic selected by a user so that the image is displayed conforming to the image characteristic; and
an image display section which displays the image based on the corrected image display information.

7. An image processing method of environment-compliant type which corrects image display information for displaying an image, based on viewing environment information indicating a viewing environment in a display area of the image, the image processing method comprising:
a step for a user to select a given image characteristic; and
a step of correcting the image display information based on the viewing environment information and the image characteristic selected by the user so that the image is displayed conforming to the image characteristic.

8. The image processing method as defined by claim 7,
wherein the image characteristic is based on at least one of image display mode and image type.

9. The image processing method as defined by claim 8, further comprising:
a step of generating a calibration image before correcting the image information;
a step of displaying the generated calibration image on the display area; and
a step of detecting the viewing environment in the display area on which the calibration image is displayed and generating the viewing environment information.

10. The image processing method as defined by claim 9,
wherein the image display information includes a look-up table.

11. The image processing method as defined by claim 9,
wherein the image display information include a color correction look-up table and a brightness correction look-up table, and
wherein the correcting step includes:
a step of correcting the color correction look-up table based on the viewing environment information and the image characteristic; and
a step of correcting the brightness correction look-up table based on the viewing environment information and the image characteristic.

12. A computer-readable information storage medium which stores program that corrects image display information for displaying an image and displays the image, based on viewing environment information obtained by a viewing environment detection means which detects a viewing environment in a display area of the image, the information storage medium comprising program to implement on a computer:
correction means which corrects the image display information based on the viewing environment information and an image characteristic selected by a user so that the image is displayed conforming to the image characteristic; and
means which causes image display means to display the image based on the corrected image display information.

13. The information storage medium as defined by claim 12,
wherein the image characteristic is based on at least one of image display mode and image type.

14. The information storage medium as defined by claim 13, further comprising program to implement means which generates the calibration image on a computer,
wherein the means which causes image display means to display the image causes the image display means to display the generated calibration image on the display area, and
wherein the viewing environment detection means detects the viewing environment in the display area on which the calibration image is displayed.

15. The information storage medium as defined by claim 14,
wherein the image display information includes a look-up table.

16. The information storage medium as defined by claim 14,
wherein the image display information includes a color correction look-up table and a brightness correction look-up table, and
wherein the correction means individually corrects the color correction look-up table and brightness correction look-up table based on the viewing environment information and the image characteristic.
